(19) United States
(12) Patent Application Publication
(10) Pub. No.: US 2013/0231129 A1
(43) Pub. Date: Sep. 5, 2013

(54) Geolocation Based Action Authorization Application And Method And System Using Same

(71) Applicant: Kendall Saville, Soquel, CA (US)

(72) Inventor: Kendall Saville, Soquel, CA (US)

(21) Appl. No.: 13/550,876

(22) Filed: Jul. 17, 2012

Related U.S. Application Data
(60) Provisional application No. 61/605,195, filed on Mar. 1, 2012.

(51) Int. Cl. H04W 64/00

(52) U.S. Cl. CPC H04W 64/00
USPC 455/456.1

(57) ABSTRACT

A system which allows a user to be found in compliance to geolocation requirements. The user may then be able to receive or purchase items related to current or past locations based upon this compliance. The compliance may be determined using an application running on a cell phone. The compliance may be determined at a first point in time, while use of the compliance may be at a significantly later time, when the user is no longer similarly geolocated. The compliance may be used to allow a user to obtain a virtual item used in the playing of an electronic game.

### CROSS-REFERENCE TO RELATED APPLICATIONS

This application claims priority of U.S. Provisional Patent Application No. 61/605,195 to Saville, filed Mar. 1, 2012, which is hereby incorporated by reference in its entirety.

### BACKGROUND

1. Field of the Invention

The present invention relates to a system for allowing activities by a user based upon compliance to geolocation requirements.

2. Description of Related Art

Location systems have been developed for determining and tracking the locations of the users of mobile devices such as cellular phones, including global positioning systems (GPS), as well as various triangulation systems that use cellular telephone signals, broadcast television signals, or the like.

The widespread use of mobile phones and the increasing sophistication of smart phones have created societies in which personal, mobile computing power has become nearly ubiquitous. Content for mobile computing devices has typically flowed from technology initially used with desktop computers. Some aspects of mobile computing devices, such as a small form factor with limited display capabilities and a lack of full-size keyboards, hinder adoption of content originally designed for desktop computers. Other aspects, such as the mobility itself, provide unique opportunities to use mobile computing devices in ways very different than the ways people use desktop computers. Development of content that recognizes the limitations while taking full advantage of the unique aspects of mobile computing devices is still an active and maturing field.

In some prior applications, the location of a user may be utilized to provide information to that user specific to that location. For example, a user may inquire, using a smart phone, about restaurants in an area local the determined location of the smart phone. A use such as this lends itself to the possibility of promotion by local restaurants, such that they may offer a coupon via the smart phone to a user who has used a searching function, thus enticing the user to attend their facility.

The use of geolocation and smart phones, or other computing devices, may also lend itself to validation of a user. The validation may allow a user to conduct a transaction only available to actors that have satisfied a location requirement. However, this validation of location need not be utilized at the time that the user is at that location, as the user may perform the activity or transaction at a later time based upon this validation. What is needed is a system and method that allows transactions based upon a user's location and/or past location.

### SUMMARY

A system which allows a user to be found in compliance to geolocation requirements. The user may then be able to receive or purchase items related to current or past locations based upon this compliance. The compliance may be determined using an application running on a cell phone. The compliance may be determined at a first point in time, while use of the compliance may be at a significantly later time, when the user is no longer similarly geolocated. In some embodiments, geolocation compliance may be part of a video game.

### BRIEF DESCRIPTION OF THE DRAWINGS

FIG. 1 is a flow chart illustrating the process of qualifying a user based upon a distance threshold.

FIG. 2 is a flow chart illustrating the purchase by a user based upon geolocation qualification.

FIG. 3 is a flow chart illustrating the geolocation qualification of a user as part of an electronic game.

FIG. 4 is a flow chart illustrating a query by a user based upon geolocation qualification.

### DETAILED DESCRIPTION

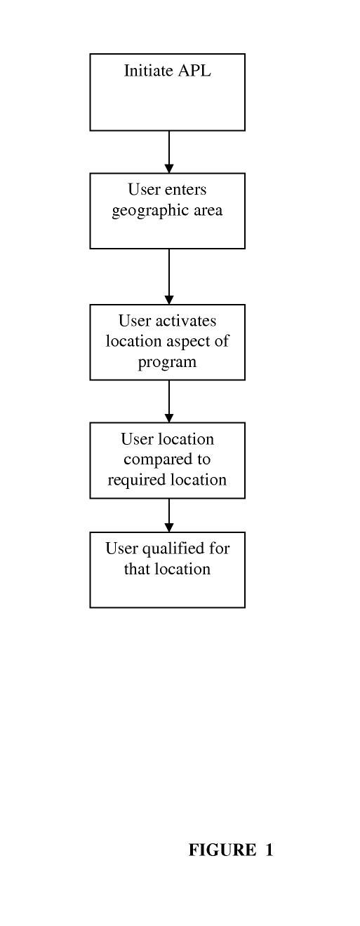

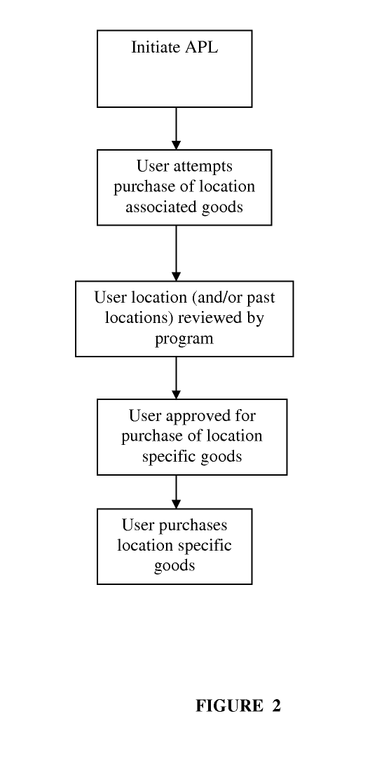

In some embodiments of the present invention, as seen in FIG. 1, the physical location of a user, as determined by a GPS function in said user's smartphone or other electronic device, may be used as a criteria for allowance of other actions by the user. In some aspects, the physical location of the user must have been recorded within a threshold distance from a pre-determined location to allow for qualification to perform an act. For example, goods related to a tourist location, such as clothing with a logo specific to that location, may be restricted as to be sold only to users who have qualified based upon current or prior location data. As seen in FIG. 2, authorization based upon current or prior location may be used to allow for purchases of goods. In some aspects, the physical location of the user may be used to allow for access to virtual items, such as may be used in a computer game, such that the virtual item is only available to a player in that computer game if that player has qualified based upon current or prior data.

Location specific goods, such as souvenirs with identifying logo related to the location, often are only available for purchase at that location. Further, the cachet of the item may be higher, making the item more desirable, when the goods are not available for purchase by persons who have not traveled to that site. For example, a coastal resort town may prefer to limit a particular shirt with a known logo to visitors to that resort. This may increase the desirability of visiting the resort in the minds of some consumers. However, the limitation that a purchaser must have visited the location need not require that the goods be purchased in person by the visitor at the time of the visit. In the increasingly internet based consumer economy, purchasers may desire that goods be available for purchase online via the Internet. This presents a problem when coupled with a desire to limit purchases to visitors to the location. In addition, online purchase may allow a purchaser to have the goods delivered directly to the visitor's home, relieving the visitor of having to transport souvenirs during a vacation or excursion.

For example, a luxury hotel resort may wish to limit the sales of items tied to that resort, such as hats, shirts, towels, etc., to people that have visited the resort. For travelers, though, the acquisition of items while traveling may be problematic due to their size, and restraints due to luggage size, for example. In some aspects, the user may be required to check into a website service for the resort in order to be authorized while at the resort. In some aspects, a third party provider may provide authorization services for the resort, as well as other merchants. The third party provider's authorization may then validate the user for purchasing the resort's items. A third party provider may be used by a number of different merchants who wish to have location validation for purchasers. In some aspects, the merchant may have the capability of authorizing the user on their own site.

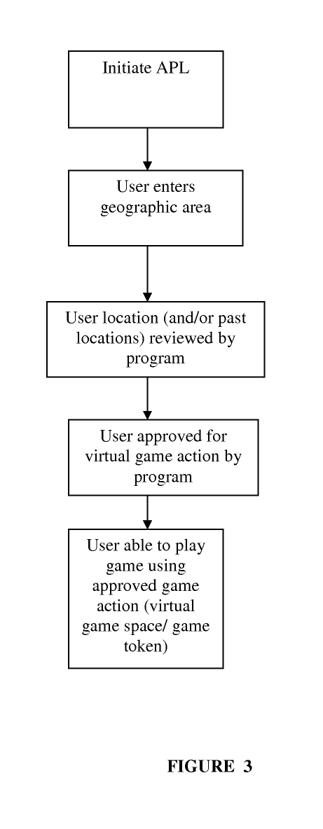

In some embodiments, as seen in FIG. 3, an application programming interface (API) used in conjunction with an electronic device such as a smartphone is adapted to be used by a user to inquire about what types of authorizations are available at a certain location. For example, a user may visit a tourist destination. While at the tourist destination, the user may use the application to inquire as to what types of items might be available only to visitors to that location. For example, there may be certain types of souvenirs that have been selected to be sold only to visitors, and these souvenirs may be from a variety of different local sources. For example, there may be a certain type of shirt available from the chamber of commerce that is only available to visitors. Also, a local resort may have a hat that is sold only to visitors to the town. The items which may only be purchased by visitors may be linked through a third party website which is turn linked to the application, allowing a visitor to view which types of items may be purchased only by a local visitor to the location where the user is at that time.

In some embodiments, an application programming interface (API) used in conjunction with an electronic device such a mobile phone, or smartphone, is adapted to confirm that the user, by virtue of the location of his/her electronic device, has visited within a threshold distance of a location. In some embodiments, the API may have available a pre-determined set of locations, which may be saved in memory within the electronic device. Upon confirmation that the user has visited a location, the API may record that the user has done so. In some embodiments, the API may transmit that the user has visited the area to another computer system at the time of the visit, which may be by a data signal sent from a smartphone. In some embodiments, the API may be adapted to transmit information about user locations to one or more of the pre-determined set of locations at a later time. In some embodiments, the API may transmit information about the user's location upon prompting by the user, such as by input into the electronic device. In some embodiments, the pre-determined locations may be available for review by the user. In some embodiments, the locations may not be available for review by the user. In some embodiments, the locations may not be pre-determined, and may be periodically updated into the API.

In an exemplary embodiment, an API may be adapted for use to qualify a user to be allowed to purchase a specific good or set of goods. The API may work in conjunction with a web based provider. The web based provider may be associated directly with the sale of the goods, or may act as an authorization gateway for others wishing to limit sales of certain goods to geographically authorized users. In this exemplary embodiment, the user has installed the application on the user's GPS enabled smartphone. When the user enters into a geographic area, the user may be able to use the application to confirm that the user had done so. For example, if the user enters City A, the user may bring up the application and input a command that directs the application to register that the user has entered City A. The application may communicate with a second computer system via a wireless network. The second computer system may then store data that indicates that the user has visited City A. In practice, visiting City A may be construed as having a GPS location as sensed by the GPS enabled smartphone that is within a threshold distance of a defined position. The second computer system may perform a verification that the GPS location as sent by the user's smartphone is within the threshold distance.

Once the verification of the location has been made, the second computer system may initiate a return communication that indicates to the user that the user has been verified as having visited City A. In some aspects, the application may then allow the user to review and/or order goods specific to City A. For example, the user may now be able to purchase an item of clothing specific to City A, such as a shirt or shorts with a City A-specific logo. In some aspects, once the verification of the visit to City A has been made, the user may be authorized to purchase or otherwise select or receive items at a later time. The duration of time available to exercise this selection may be a prescribed amount of time.

In some aspects, the application may retain the data that indicates that the user has visited a location, and that data may be transferred to a second computer system at a later time. For example, the application may create a record of the locations visited by the user. The application may then later interact with a second computer system and transmit the location/visit data to the second computer system. Based upon this location/visit data, the user may then be authorized to purchase, select, or utilize items. There may be a plurality of items available for having visited a particular location. There may be a plurality of items available, each being available based upon visiting different locations.

The mobile device may include one or more processors and a memory. The memory may contain a user identification module that in turn contains a user identifier, user information, a transaction module, and a security module. The user identification may be a unique number or code that uniquely identifies the user of the mobile device. This user identification may be the same user identification that the user uses for interacting with online merchants and the like. In some implementations, the user identification may be entered by the user into the mobile device during a setup procedure such as by entering a user name and a password. In other implementations, the user identification may be included in hardware of the mobile device. For example, a unique serial number of the mobile device may be linked with a user name and password when the user purchases the device. As a further example, a subscriber identification module (SIM) on a removable SIM card within the device may contain the user identification. In this example, the user identification may be transferred between devices by moving the SIM card.

The device may also contain user information stored locally in the memory. This information may be configurable by the user and can include payment information, a home location, and/or map of the device's past movements, past transaction histories, and/or any other information related to the user.

The transaction module may recognize when the mobile device is located within a threshold distance of a specific location and, in response, may authorize a transaction related to that specific location. The transaction may be based in part on the user information. The transaction module may be configured with appropriate application programming interfaces (APIs) to establish a standard communication protocol for providing corresponding information about the user (e.g., location information and user identification). In some implementations, the transaction module is a software application that a user may install on his or her device such as by downloading from a website. In other implementations, the transaction module may be preinstalled by a manufacturer or retailer of the mobile device and/or built into the mobile device as a type of firmware or hardware. The transaction module coordinates the user identification, user information, geolocation, and the like to facilitate transactions by the user.

The mobile device may also include one or more input and output devices. The output devices may comprise one or more display devices including touch-screen displays that also function as an input device. An accelerometer detects rotation or vibration of the mobile device. The accelerometer may be a convenient mechanism for the user to communicate an input to the mobile device by slapping, shaking, twisting, and/or by making a motion that can be detected by the accelerometer. An antenna in the mobile device may send and receive wireless signals from sources such as the radio antenna and satellite. The device may further comprise other input/output devices, such as a microphone and a speaker used, for example, in an implementation in which the mobile device functions as a telephone.

In some implementations, the mobile device may also include a calendar/clock, a location sensor, and a network interface. The calendar/clock may calculate time, date, and other data that can be derived from time data and date data. In some implementations, the calendar/clock may communicate with the location sensor to determine, for example, the time at which the device was at the current location of the device.

The calendar/clock and the location sensor may also communicate to create a log of where the device is located at numerous time points. The log of time-place data may be compiled into a map that shows movements of the device overtime and throughout different dates. This map may be stored in the memory, for example as a part of the user information. The location sensor includes any sort of system that informs the mobile device of its geolocation including, but not limited to, the Global Positioning System of satellites circling the Earth. Alternatively, the location sensor may determine geolocation by radio signal triangulation (e.g., triangulation based on radio antenna signal strength).

The network interface may be configured for wirelessly communicating with the network. The network interface may use any standard protocols for network communication. The network interface may be capable of high speed, wireless network communication. In some implementations, the network interface may use the antenna to send and receive data from the network. In further implementations, a network interface may provide information to the location sensor (e.g., a closest network access point) from which the location sensor can infer or calculate a location of the mobile device.

Aspects of the system utilizing an application programming interface may also reside on one or more servers. One or more servers may be implemented as a single computing device, a server farm comprising multiple servers, a distributed network, a cloud-computing configuration, and/or the like. The server(s) comprises one or more processors and a memory. The memory may contain the same user identifier associated with the mobile device. In some implementations, memory may contain thousands or even millions of separate user identifiers. Each user identifier may be associated with a respective mobile device, and thus to an identified user.

The user identifier represents a user that is interacting with the server(s) via a mobile device. An authentication module may be used to determine if communications coming from the mobile device should be associated with the user identifier. In some implementations, authorization may involve handshaking or other verification between, for example, the authentication module of the server(s) and the security module of the mobile device.

Transactions between the user and a merchant, or related to a specific set of goods from that merchant and coupled to a particular location, may be facilitated by the transaction module when a geolocation of the device matches or is within a threshold distance of a geolocation of the merchant.

A map stored on the server(s) may contain geolocations of particular sites, such as cities, points of interest, tourist destinations, and the like. Correlation between a particular subset of goods and a particular geolocation may allow the user to be authorized to acquire those goods. The map may also contain real-time information about the geolocations of each of the mobile devices associated with the respective user identifiers.

In some embodiments, an API may be adapted for use to qualify a user to be allowed to obtain a specific item or set of items related to use in a video game, or online game. The API may work in conjunction with a web based provider. The web based provider may be associated directly with the game, or may act as an authorization gateway for others wishing to limit obtaining of certain items, or authorizations, to geographically authorized users. In this exemplary embodiment, the user has installed the application on the user's GPS enabled smartphone. When the user enters into a geographic area, the user may be able to use the application to confirm that the user had done so. For example, if the user enters City A, the user may bring up the application and input a command that directs the application to register that the user has entered City A. The application may communicate with a second computer system via a wireless network. The second computer system may then store data that indicates that the user has visited City A. In practice, visiting City A may be construed as having a GPS location as sensed by the GPS enabled smartphone that is within a threshold distance of a defined position. The second computer system may perform a verification that the GPS location as sent by the user's smartphone is within the threshold distance.

In the case of use with a gaming application, the locations may be locations within an urban area, for example. In some applications, by visiting a location, the user may be authorized to obtain a virtual item which may be used in the playing of game. In some applications, by visiting a location, the user may be authorized to enter into a virtual area of part of a game space used in the playing of a game.

In some embodiments, a game may involve the qualification of a player/user to play in certain virtual regions which are part of the game based upon the visitation of the player/user to that region. The user may qualify by coming within a threshold distance of that region, or by entering into that region. The qualification may be achieved by the entrance into that region, or within a threshold distance of that region, of a designated device. In some embodiments, this may be a GPS enabled mobile telephone, which may be a smart phone.

For example, in the case of a game which uses the entire world as a virtual game space, if the user goes to Europe this may allow the user then to play a different virtual portion of the game keyed to Europe, or may allow the user access to virtual items (to be used in the game) keyed/linked to having gone to Europe.

In some embodiments, the game may be a game which allows for competition between different players. This may be a cloud version, or internet based version of the game, for example. The opponents that the user plays against may be keyed upon the location of the user, or upon locations that the user has previously visited.

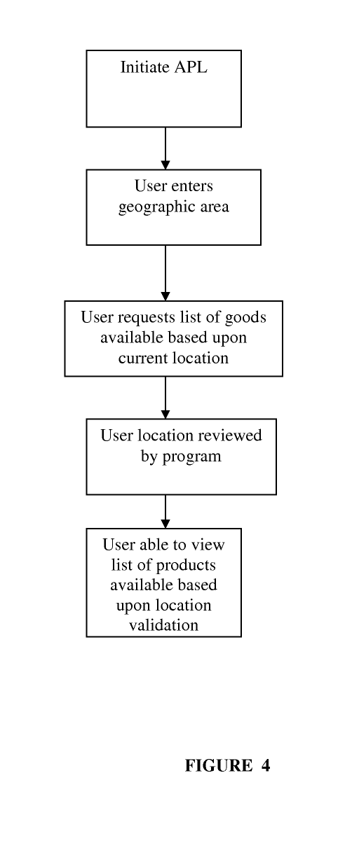

In some embodiments, as seen in FIG. 4, users of the game may seek to travel such that they are able to expand the virtual game space in which they are allowed to play. For example, separate from aspects of the game which may take a level of skill while playing against the game itself, or against other players who are opponents in an internet based game, an aspect of the competition may also involve traveling to multiple destinations. In the case of a world-based game, travel may include traveling to a variety of continents, countries, and cities. In the case of a city-based game, travel may involve traveling to areas within a city.

In some embodiments, the game may be partitioned by states. For example, when the user has traveled into a state, that state may become part of a virtual game space into which the user may now enter when playing a video game. As the user travels into another state, that state may become authorized as described previously. With this authorization, a video game may the allow the user into a virtual representation of this state.

In some embodiments, a resort area such as a ski/snowboard resort may be coupled to a game which may simulate the resort area. For example, the ski/snowboard area may in reality have ski runs, as well as snow park areas adapted for snowboard freestyle events, such as pipes and other features. In the coupled game, there may also be such features in a virtual sense. The user may only be able to play the game if the user has met a qualification based upon geolocation. Thus a qualified user may be able to virtually re-create the enjoyment of the prior visit to the resort using a game space authorized by having met the geolocation requirements of the game.

In some embodiments, the user may be able to access ski runs that the user has previously visited. Thus, the user may be incentivized to travel into more areas of the ski area such that they become authorized in a virtual representation of the ski area in a computer hosted video game.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. One or more computer-readable storage media storing computer-executable instructions that, when executed by one or more processors, cause the one or more processors to perform acts comprising:
determining that a first mobile device is within a threshold distance of a first location; and
storing data indicating that said mobile device was within a threshold distance of said first location.

2. The computer-readable storage media of claim 1 storing computer-readable instructions that, when executed by one or more persons, cause the one or more processors to perform acts further comprising:
determining that said first mobile device is within a threshold distance of a second location; and
storing data indicating that said mobile device was within a threshold distance of said second location.

3. The computer-readable storage media of claim 1 storing computer-readable instructions that, when executed by one or more persons, cause the one or more processors to perform acts further comprising:
storing data indicating the time at which said mobile device was within said threshold distance of said first location.

4. The computer-readable storage media of claim 2 storing computer-readable instructions that, when executed by one or more persons, cause the one or more processors to perform acts further comprising:
storing data indicating the time at which said mobile device was within said threshold distance of said first location; and
storing data indicating the time at which said mobile device was within said threshold distance of said second location.

5. The computer-readable storage media of claim 1 storing computer-readable instructions that, when executed by one or more persons, cause the one or more processors to perform acts further comprising:
granting a permission to a first user based upon a determination that said mobile device was within a threshold distance of said first location.

6. The computer-readable storage media of claim 5 storing computer-readable instructions that, when executed by one or more persons, allow the one or more processors to perform acts based upon the permission granted to said first user for a first specified period of time.

7. The computer-readable storage media of claim 5 storing computer-readable instructions that, when executed by one or more persons, allow the one or more processors to perform acts based upon said permission comprising allowing said first user to purchase an item paired to said first location.

8. The computer-readable storage media of claim 6 storing computer-readable instructions that, when executed by one or more persons, cause the one or more processors to perform acts further comprising allowing said first user to purchase an item paired to said first location during said first specified period of time.

9. The computer-readable storage media of claim 5 storing computer-readable instructions that, when executed by one or more persons, allow the one or more processors to perform acts based upon said permission comprising allowing said first user to obtain access to a virtual game space paired to said first location, wherein said virtual game space is used in the playing of an electronic game.

10. The computer-readable storage media of claim 5 storing computer-readable instructions that, when executed by one or more persons, allow the one or more processors to perform acts based upon said permission comprising allowing said first user to obtain a virtual item paired to said first location, wherein said virtual item is used in the playing of an electronic game.

11. The computer-readable storage media of claim 5 storing computer-readable instructions that, when executed by one or more persons, allow the one or more processors to perform acts based upon said permission comprising allowing said first user to obtain engage other users paired to said first location in the playing of an electronic game.

12. One or more computer-readable storage media storing computer-executable instructions that, when executed by one or more processors, cause the one or more processors to perform acts comprising:
determining that a first mobile device of a user is within a threshold distance of a first location;
determining one or more items available to users within said threshold distance of said first location; and
transmitting a list of said items to said first mobile device.
